(19) United States
(12) Patent Application Publication
(10) Pub. No.: US 2026/0145736 A1
(43) Pub. Date: May 28, 2026

(54) Method for Operating and/or Influencing a Steering System, Steering System and a Vehicle comprising the Steering System

(71) Applicant: Robert Bosch GmbH, Stuttgart (DE)

(72) Inventors: Arnulf Heilig, Schwaebisch Gmuend (DE); David Schmitz, Mundelsheim (DE); Nico Spieth, Waiblingen (DE); Reinhard Grossheim, Abtsgmuend (DE); Sebastian Pelludat, Schorndorf (DE)

(21) Appl. No.: 19/394,169

(22) Filed: Nov. 19, 2025

(30) Foreign Application Priority Data
Nov. 22, 2024 (DE) 10 2024 211 218.6

(51) Int. Cl. B62D 6/00

(52) U.S. Cl. CPC B62D 6/008

(57) ABSTRACT

A steering system, a vehicle including a steering system, and a method for operating and/or influencing a steering system, in particular, a steer-by-wire steering system are disclosed. The method includes (i) providing an external first target variable that characterizes a target actuator position of a steering actuator, (ii) ascertaining a target position for an operating element of an input device as a function of the external first target variable, wherein the operating element forms an interface between a user of the steering system and the steering system, wherein an actual position of the operating element is influenceable by the user, (iii) ascertaining an actuator signal for an actuator of the input device, by way of which the actual position of the operating element is influenced, as a function of the target position and an actual position of the operating element, (iv) ascertaining a second target variable that characterizes the target actuator position of the steering actuator as a function of the actual position of the operating element, (v) ascertaining a limited target variable as a function of the external first target variable and the second target variable, wherein the limited target variable is limited by at least one predefined limit value, and (vi) ascertaining the target actuator position for the steering actuator as a function of the second target variable and the limited target variable.

This application claims priority under 35 U.S.C. § 119 to application no. DE 10 2024 211 218.6, filed on Nov. 22, 2024 in Germany, the disclosure of which is incorporated herein by reference in its entirety.

### BACKGROUND

The present disclosure relates to a method for operating and/or influencing a steering system, and to a steering system and a vehicle comprising the steering system.

In assisted driving, for example, at an SAE L1, SAE L2, or SAE L2+ level according to SAE J3016, a vehicle having a steering system, in particular, a steer-by-wire steering system, detects a target trajectory and ascertains a corresponding target position, for example, of a steering angle, a road-wheel angle, and/or a rack position of a rack actuator of the steering system, in order to implement this target trajectory. The steering system detects a change in the target position in an assisted operating mode of the vehicle in cooperation with a driver of the vehicle or a user of the steering system, or independently of the driver in an autonomous operating mode of the vehicle or during autonomous driving. For example, autonomous driving is assigned to an SAE L3 level or higher according to SAE J3016, and assisted driving is assigned, for example, to an SAE level below SAE L3. For example, in assisted driving at SAE L2 or SAE L1, an input from the driver must have a higher priority than a target trajectory ascertained by the vehicle.

Accordingly, a steering system is desirable that enables precise control of a steering angle and provides a driver or user with reliable feedback, for example, through a movement of the steering wheel, which characterizes a corresponding steering angle. In addition, the driver or user should be provided with a precise intervention option.

### SUMMARY

This is achieved by a method, a steering system, and a vehicle comprising the steering system according to description set forth below.

The method for operating and/or influencing a steering system, in particular, a steer-by-wire steering system, comprises: Providing an external first target variable that characterizes a target actuator position of a steering actuator, in particular, of a rack actuator, for example, by a control unit; ascertaining a target position for an operating element of an input device as a function of the external first target variable, wherein the operating element forms an interface between a user of the steering system and the steering system, for example, a steering handgrip, wherein an actual position of the operating element is influenceable by the user; ascertaining an actuator signal for an actuator of the input device, by way of which the actual position of the operating element is influenced, as a function of the target position and an actual position of the operating element; ascertaining a second target variable that characterizes the target actuator position of the steering actuator as a function of the actual position of the operating element; ascertaining a limited target variable as a function of the external first target variable and the second target variable, wherein the limited target variable is limited by at least one predefined limit value; and ascertaining the target actuator position for the steering actuator as a function of the second target variable and the limited target variable. By ascertaining the target actuator position of the steering actuator as a function of the external first target variable, the external first target variable directly influences the steering actuator, allowing the steering actuator to be precisely and rapidly regulated to the setpoint specified by the target variable. In addition, a user-perceived steering feel of the operating element may be applied as desired, regardless of influences of the steering actuator and/or a chassis. In addition, only one interface is required between the steering actuator and the input device, which ensures a high safety standard of the steering system.

It may be provided that, in ascertaining the limited target variable, the second target variable is subtracted from the external first target variable, wherein a result of this subtraction is limited by way of the at least one limit value. This improves the efficiency of the method and enables a low-complexity implementation.

It may be provided that, in ascertaining the target actuator position, the second target variable and the limited target variable are added. This improves the efficiency of the method and enables a low-complexity implementation.

In one example, the method comprises ascertaining an actuator signal for an actuator of the steering actuator as a function of the target actuator position, and an actual actuator position of the steering actuator, wherein the actuator signal characterizes, in particular, a drive torque for the actuator.

The steering system, in particular, a steer-by-wire steering system, comprises a steering actuator and an input device that includes an operating element, wherein the steering system is configured to: ascertain a target position for the operating element of the input device as a function of an external first target variable provided, for example, by a control unit and characterizing a target actuator position of the steering actuator, in particular, of a rack actuator, wherein the operating element forms an interface between a user of the steering system and the steering system, for example, a steering handgrip, wherein an actual position of the operating element is influenceable by the user; ascertain an actuator signal for an actuator of the input device that influences the actual position of the operating element, as a function of the target position and the actual position of the operating element; ascertain a second target variable that characterizes the target actuator position of the steering actuator as a function of the actual position of the operating element; ascertain a limited target variable as a function of the external first target variable and the second target variable, wherein the limited target variable is limited by at least one predefined limit value; and ascertain the target actuator position for the steering actuator as a function of the second target variable and the limited target variable.

It may be provided that the steering system is configured, in ascertaining the limited target variable, to subtract the second target variable from the external first target variable and to limit a result of this subtraction by way of the at least one limit value.

It may be provided that the steering system is configured, in ascertaining the target actuator position, to add the second target variable and the limited target variable.

It may be provided that the steering system is configured to ascertain an actuator signal for an actuator of the steering actuator as a function of the target actuator position and an actual actuator position of the steering actuator, wherein the actuation signal characterizes, in particular, a drive torque for the actuator.

The vehicle comprises the steering system according to the above embodiment, wherein the steering system is configured, in particular, to carry out a method according to the above embodiment, and to influence a driving trajectory, in particular, by positioning at least one wheel of the vehicle, wherein the at least one wheel is operatively connected to the steering actuator, for example, by way of a rack.

### BRIEF DESCRIPTION OF THE DRAWINGS

Further embodiments are shown in the drawing and the following description. The drawing shows:

FIG. 1 a block diagram of a steering system;

FIG. 2 a method for operating and/or influencing the steering system;

FIG. 3 a schematic representation of a vehicle comprising the steering system;

FIG. 4 a time profile of variables of the steering system;

FIG. 5 a time profile of variables of the steering system;

### DETAILED DESCRIPTION

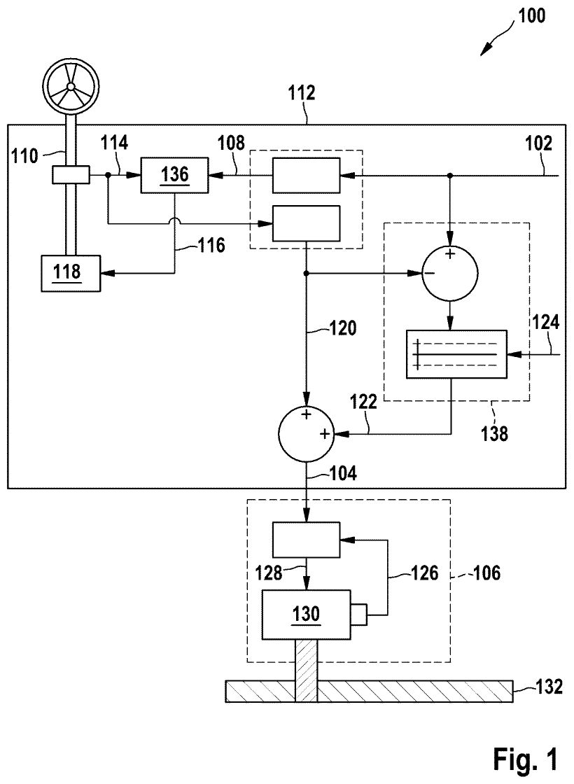

FIG. 1 shows a steering system 100 in a schematic representation. The steering system 100 is configured as a steer-by-wire steering system, for example, and is used to steer a vehicle. The steering system 100 comprises a steering actuator 106 and an input device 112 comprising an operating element 110. The operating element 110 may be configured as a handgrip to be manipulated by a user of the steering system 100. For example, the operating element 110 may be a steering handgrip, a steering wheel or a joystick. The operating element 110 forms an interface between the user and the steering system 100, enabling the user to make inputs to the steering system 100, such as a steering command for steering the vehicle.

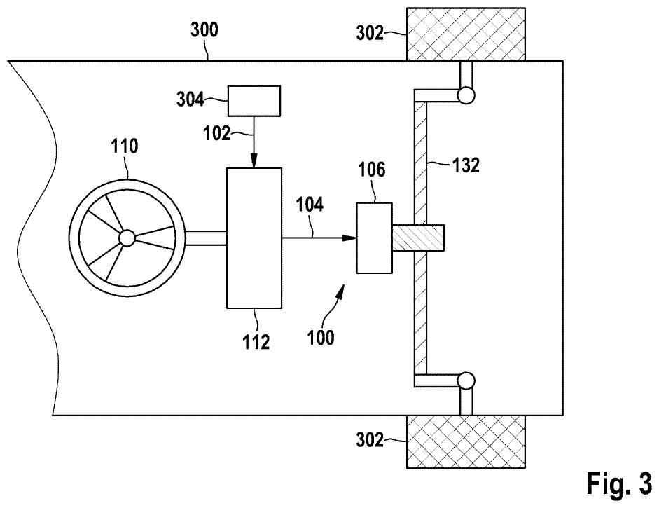

The steering system 100 is configured to ascertain a target position 108 for the operating element 110 of the input device 112 as a function of an externally provided first target variable 102, which characterizes a target actuator position 104 of the steering actuator 106. For example, the externally provided first target variable 102 may be provided by a control unit 304 (FIG. 3) of a vehicle comprising the steering system 100. For example, the control unit 304 may be provided decentralized to the steering system 100. For example, the external first target variable 102 is read in or retrieved by the steering system 100 and subsequently processed further. For example, the external first target variable 102 characterizes target trajectory of the vehicle that is ascertained by the control unit as part of an assisted or autonomous driving application of the vehicle. For example, this target trajectory is achieved by a corresponding target actuator position 104 of the steering actuator 106.

For example, the target position 108 is a rotational angle of the operating element 110 and represents, in a manner perceptible to the user, a current position of the steering actuator 106. For example, the steering actuator 106 is configured as a rack actuator.

The steering system 100 is configured to ascertain an actuator signal 116 for an actuator 118 of the input device 112, which influences the actual position 114 of the operating element 110, as a function of the target position 108 and the actual position 114 of the operating element 110. Therefore, the actual position 114 is influenceable by the actuator and the user. For example, actuator signal 116 may be ascertained by way of a position controller 136.

The steering system 100 is configured to ascertain a second target variable 120, which characterizes the target actuator position 104 of the steering actuator 106, as a function of the actual position 114 of the operating element 110. The target actuator position 104 of the steering actuator 106 is influenced in the present steering system 100 by the external first target variable 102 and/or the second target variable 120. For example, the external first target variable represents an influence of an assisted-driving or autonomous-driving application, while the second target variable represents an influence of the user, for example, a steering input.

The steering system 100 is configured to ascertain a limited target variable 122 as a function of the external first target variable 102 and the second target variable 120, wherein the limited target variable 122 is limited by at least one predefined limit value 124. The at least one predefined limit value 124 may be applied to achieve, for example, a desired steering behavior.

The steering system 100 is configured to ascertain the target actuator position 104 for the steering actuator 106 as a function of the second target variable 120 and the limited target variable 122. As a result, user influences are taken into account by the second target variable (120), influences, for example, from an application for assisted or autonomous driving are taken into account by the external first target variable (102), and a desired steering behavior of the steering system (100) is taken into account by the at least one predefined limit value (124) in ascertaining the target actuator position (104) of the steering actuator (106). Through such ascertaining, an essentially direct influence of the external first target variable 102 via a bypass 138 is possible.

It may be provided that the steering system 100 is configured, in ascertaining the limited target variable 122, to subtract the second target variable 120 from the external first target variable 102 and to limit a result of this subtraction by way of the at least one limit value 124. For example, the at least one limit value 124 causes the limited target variable 122 to remain within a range spanned by the at least one limit value 124. For example, the limited target variable 122 may thus assume at most a value of the at least one predefined limit value 124. For example, the at least one predefined limit value 124 may amount to ±1 mm.

It may be provided that the steering system (100) is configured, in ascertaining the target actuator position (104), to add the second target variable (120) and the limited target variable (122).

It may be provided that the steering system 100 is configured to ascertain an actuator signal 128 for an actuator 130 of the steering actuator 106 as a function of the target actuator position 104 and an actual actuator position 126 of the steering actuator 106, wherein the actuator signal 128, in particular, characterizes a drive torque for the actuator 130. For example, the actuator 130 may be an electric drive. It may be provided that the steering actuator 106 is configured as a rack actuator and comprises a rack 132. In this case, the target actuator position 104 and the actual position 126 characterize, for example, a position of the rack, in particular, in millimeters.

By way of the at least one limit value 124, a dynamic behavior, in particular, a guidance behavior between the external first target variable 102 and the actual actuator position 126 or the target actuator position 104, may be influenced, for example. Furthermore, the at least one limit value 124 influences, for example, a delay between a steering command of the user, which affects the actual position 114 of the operating element 110, and a corresponding effect of the target actuator position 104 or the actual actuator position 126. For example, the at least one limit value 124 may be specified variably as a function of a motion state of the vehicle and/or a selected operating mode of the vehicle, or be applied as a constant parameter.

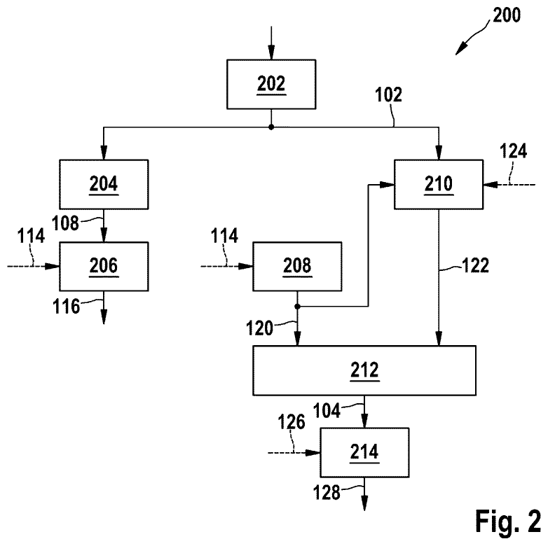

FIG. 2 shows a flow diagram of a method (200) for operating and/or influencing a steering system (100), in particular, a steer-by-wire steering system. The method comprises providing 202 the external first target variable 102, which characterizes the target actuator position 104 of the steering actuator 106, and ascertaining 204 the target position 108 for the operating element 110 of the input device 112 as a function of the external first target variable 102, wherein the operating element 110 forms an interface between the user of the steering system 100 and the steering system 100, wherein the actual position 114 of the operating element 110 is influenceable by the user. For example, the method 200 may be used in assisted-driving or autonomous-driving for operating and/or influencing the steering system 100. For example, the method 200 may be used as a general interface for operating the steering system 100, irrespective of the operating state of the vehicle comprising the steering system 100.

The method 200 comprises ascertaining 206 the actuator signal 116 for the actuator 118 of the input device 112, by way of which the actual position 114 of the operating element 110 is influenced, as a function of the target position 116 and the actual position 114 of the operating element 110.

The method 200 comprises ascertaining 208 the second target variable 120, which characterizes the target actuator position 104 of the steering actuator 106, as a function of the actual position 114 of the operating element 110, and ascertaining 210 the limited target variable 122 as a function of the external first target variable 102 and the second target variable 120, wherein the limited target variable 122 is limited by at least one predefined limit value 124.

The method 200 comprises ascertaining 212 the target actuator position 104 for the steering actuator 106 as a function of the second target variable 120 and the limited target variable 122.

It may be provided that, in ascertaining 210 the limited target variable 122, the second target variable 120 is subtracted from the external first target variable 102, wherein the result of this subtraction is limited by the at least one limit value 124.

It may be provided that, in ascertaining 212 the target actuator position 104, the second target variable 120 and the limited target variable 122 are added.

It may be provided that the method 200 comprises ascertaining 214 an actuator signal 128 for an actuator 130 of the steering actuator 106 as a function of the target actuator position 104 and an actual actuator position 126 of the steering actuator 106, wherein the actuator signal 128, in particular, characterizes a drive torque for the actuator 130.

It may be provided that a plurality of the above-mentioned steps of the method 200 are carried out simultaneously.

FIG. 3 shows a vehicle 300 comprising the steering system 100 according to the above embodiment, wherein the steering system 100 is configured, in particular, to carry out the method 200 according to the above embodiment, and to influence a driving trajectory of the vehicle 300, in particular, by positioning at least one wheel 302 of the vehicle 300, wherein the at least one wheel 302 is operatively connected to the steering actuator 106, for example, via a rack 132.

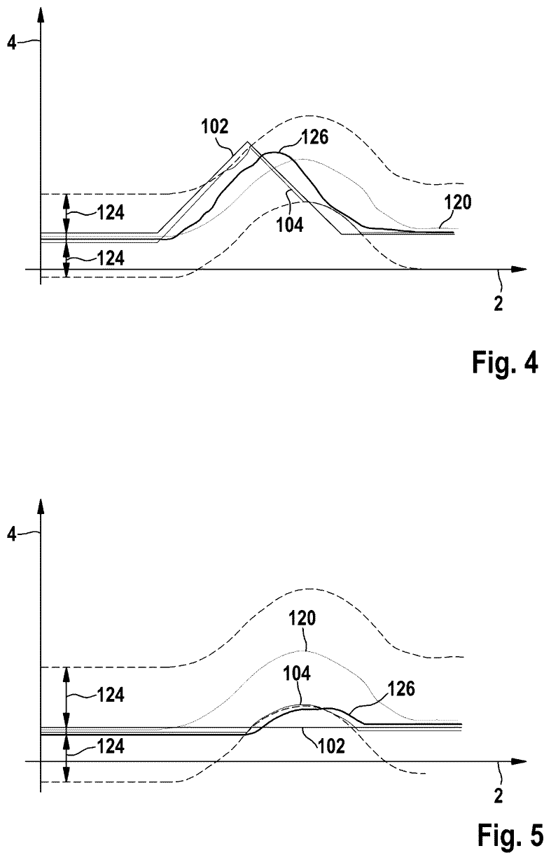

FIG. 4 shows a profile of variables of the steering system 100 in the form of a position 4 plotted over time 2. FIG. 4 shows a behavior of the steering system 100 in an example in which there is no intervention or input by the user. The profile of the external first target variable 102 shows that a change in the actual actuator position 126 is desired. The target actuator position 104 directly follows the external first target variable 102, as a result of which the actual actuator position 126 likewise directly follows it, taking into account internal inertias of the steering system 100. Due to internal inertias, the operating element 110 likewise follows the external first target variable 102 in its position, as represented by the second target variable 120 shown in the profile. The target actuator position (104) follows the external first target variable (102) directly until the external first target variable is limited by the limited target variable (122) in the course of ascertaining (212) by way of the at least one predefined limit value (124). In the example shown, the target actuator position 104 no longer exhibits the same dynamic behavior as the external first target variable 102 after the limitation, but instead follows the dynamic behavior of the second target variable 120.

FIG. 5 shows a profile of variables of the steering system 100 in the form of a position 4 plotted over time 2. In the example shown in FIG. 5, an intervention by the user is present, which is recognizable from the profile of the second target variable 120. Due to the at least one limit value (124), this input has no effect on the target actuator signal (104), as a result of which the actual actuator signal (126) likewise does not change. As a result, a delay that is adaptable by way of the at least one limit value 124 arises between the input of the user, in the form of the second target variable 120, and a corresponding change of the target actuator position 104. This delay persists until the limited target variable 122 has exceeded the at least one predefined limit value 124.

What is claimed is:

1. A method for operating and/or influencing a steering system, comprising:
providing an external first target variable that characterizes a target actuator position of a steering actuator;
ascertaining a target position for an operating element of an input device as a function of the external first target variable, wherein the operating element is an interface between a user of the steering system and the steering system, and wherein an actual position of the operating element is influenceable by the user;
ascertaining an actuator signal for an actuator of the input device, by way of which the actual position of the operating element is influenced, as a function of the target position and of the actual position of the operating element;
ascertaining a second target variable, which characterizes the target actuator position of the steering actuator, as a function of the actual position of the operating element;
ascertaining a limited target variable as a function of the external first target variable and the second target variable, wherein the limited target variable is limited by at least one predefined limit value; and
ascertaining the target actuator position for the steering actuator as a function of the second target variable and the limited target variable.

2. The method according to claim 1, wherein, in ascertaining the limited target variable, the second target variable is subtracted from the external first target variable, and wherein a result of this subtraction is limited by way of the at least one limit value.

3. The method according to claim 1, wherein, in ascertaining the target actuator position, the second target variable and the limited target variable are added.

4. The method according to claim 1, further comprising:
ascertaining an actuator signal for an actuator of the steering actuator, as a function of the target actuator position, and an actual actuator position of the steering actuator, wherein the actuator signal characterizes a drive torque for the actuator.

5. A steering system, comprising a steering actuator and an input device which comprises an operating element, wherein the steering system is configured to:
ascertain a target position for the operating element of the input device as a function of an external first target variable, which is provided by a control unit, and characterizes a target actuator position of the steering actuator, wherein the operating element forms an interface between a user of the steering system and the steering system, and wherein an actual position of the operating element is influenceable by the user;
ascertain an actuator signal for an actuator of the input device, which influences the actual position of the operating element, as a function of the target position and the actual position of the operating element;
ascertain a second target variable, which characterizes the target actuator position of the steering actuator, as a function of the actual position of the operating element;
ascertain a limited target variable, as a function of the external first target variable and the second target variable, wherein the limited target variable is limited by at least one predefined limit value; and
ascertain the target actuator position for the steering actuator, as a function of the second target variable and the limited target variable.

6. The steering system according to claim 5, wherein the steering system is configured, in ascertaining the limited target variable, to subtract the second target variable from the external first target variable and to limit a result of this subtraction by way of the at least one limit value.

7. The steering system according to claim 5, wherein the steering system is configured, in ascertaining the target actuator position, to add the second target variable and the limited target variable.

8. The steering system according to claim 5, wherein the steering system is configured to ascertain an actuator signal for an actuator of the steering actuator, as a function of the target actuator position, and an actual actuator position of the steering actuator, wherein the actuator signal characterizes a drive torque for the actuator.

9. A vehicle comprising the steering system according to claim 5, wherein the steering system is configured to carry out a method for operating and/or influencing the steering system and to influence a driving trajectory by positioning at least one wheel of the vehicle, wherein the at least one wheel is operatively connected to the steering actuator via a rack.

10. The method according to claim 1, wherein the steering system is a steer-by-wire steering system.

11. The steering system according to claim 5, wherein the steering system is a steer-by-wire steering system.

12. A vehicle comprising a steering system, wherein the steering system is configured to carry out the method according to claim 1, and to influence a driving trajectory by positioning at least one wheel of the vehicle, wherein the at least one wheel is operatively connected to the steering actuator via a rack.
